(19) United States
(12) Patent Application Publication
(10) Pub. No.: US 2014/0374182 A1
(43) Pub. Date: Dec. 25, 2014

(54) System, Method and Device for Disabling a Motorized Vehicle

(71) Applicant: Artis L. Williams, Dallas County, TX (US)

(72) Inventor: Artis L. Williams, Dallas County, TX (US)

(21) Appl. No.: 13/922,234

(22) Filed: Jun. 19, 2013

(51) Int. Cl. B60R 25/045; G01S 7/02; G07C 5/08; F41H 13/00

(52) U.S. Cl. CPC B60R 25/045; F41H 13/0093; G01S 7/022; G07C 5/085
USPC 180/167

(57) ABSTRACT

A system and method to disable a motorized vehicle includes a modified police radar/laser gun, a black box, which stops a vehicle by shutting down the electrical system or by other means known in the art when activated by the modified police radar/laser gun. The black box is attached to the motorized vehicle and is activated by the modified police radar/laser gun during a chase or other emergency situation. The black box is tamper proof so that any attempt to remove or otherwise tamper with it will disable the vehicle so that it will not start. A system according to the present invention works on automobiles, trucks, buses, eighteen wheelers, recreational vehicles, motorcycles and boats. Starting the vehicle readies the system.

### CROSS-REFERENCE TO RELATED APPLICATIONS

Applicant claims rights through Provisional Patent Application Number 61/661,425 filed Jun. 19, 2012 entitled System and Method for Disabling a Motorized Vehicle.

### STATEMENT REGARDING FEDERALLY SPONSORED RESEARCH OR DEVELOPMENT

Not Applicable

### INCORPORATION-BY-REFERENCE OF MATERIAL SUBMITTED ON A COMPACT DISC

Not Applicable

### BACKGROUND OF THE INVENTION

1. Field of the Invention

The current invention relates generally to theft prevention devices for motorized vehicles, and in particular, for a method, an apparatus and a system to disable a motorized vehicle during a police chase.

2. Description of Related Art

### BRIEF SUMMARY OF THE INVENTION

A system according to the present invention to disable a motorized vehicle includes a modified police radar/laser gun used by a police chase vehicle, a black box, known as a stinger or a Wi-Fi receiver or other device such as a chip embedded in a license plate of the vehicle being chased by the police, which stops a vehicle by shutting down the electrical system or by other means known in the art when activated by the modified police radar/laser gun during a chase or other emergency situation. The black box is attached to the motorized vehicle and is activated by the modified police radar/laser gun. Just as a police radar/laser gun can single out an individual vehicle, so the modified police radar/laser gun can single out a single vehicle for disabling. The black box is tamper proof so that any attempt to remove or otherwise tamper with it will disable the vehicle so that it will not start.

A system according to the present invention works on automobiles, trucks, buses, eighteen wheelers, recreational vehicles, motorcycles and boats. Starting the vehicle readies the system. A system according to the present invention is well suited for police chases generally, but it is especially well suited for use with “bait cars” that are sometimes used by the police in areas with a lot of car theft.

These and other objects, advantages and features of this invention will be apparent from the following description taken with reference to the accompanying drawing, wherein is shown a preferred embodiment of the invention.

### BRIEF DESCRIPTION OF THE SEVERAL VIEWS OF THE DRAWING

FIG. 1 is an aerial view of a police chase using the present invention;

FIG. 2 shows a chip according to the present invention embedded in a rear license plate;

FIG. 3 shows a perspective view of a modified radar/laser gun according to the present invention;

FIG. 4 shows a diagrammatic representation of the modified radar/laser gun according to FIG. 3; and

FIG. 5 is a diagrammatic representation of one embodiment of the present invention.

### DETAILED DESCRIPTION OF THE INVENTION

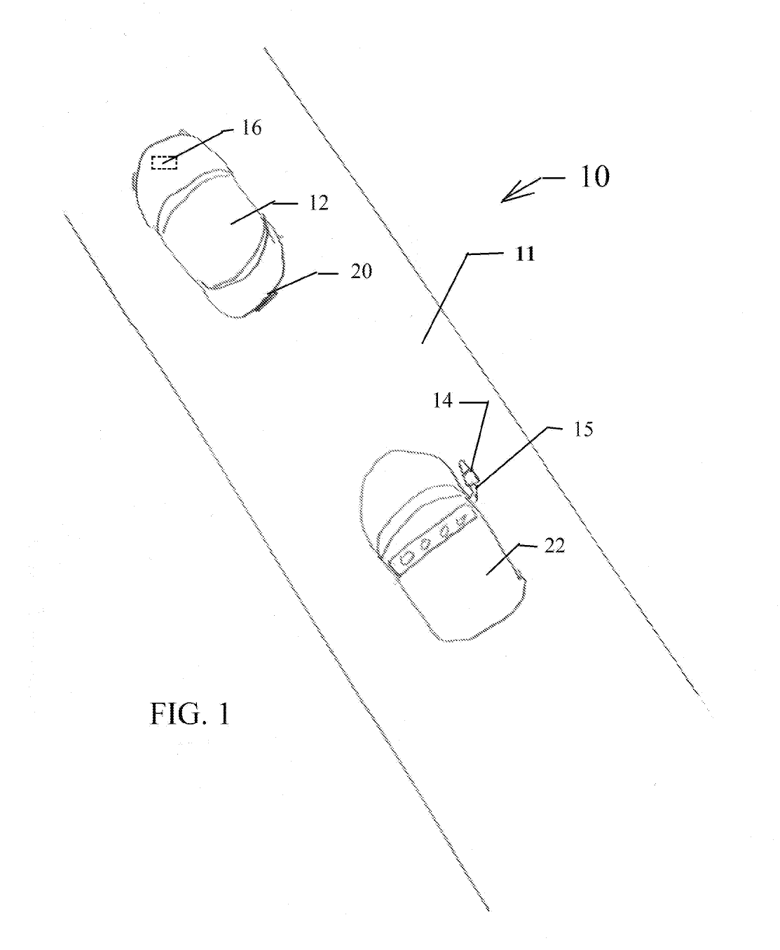

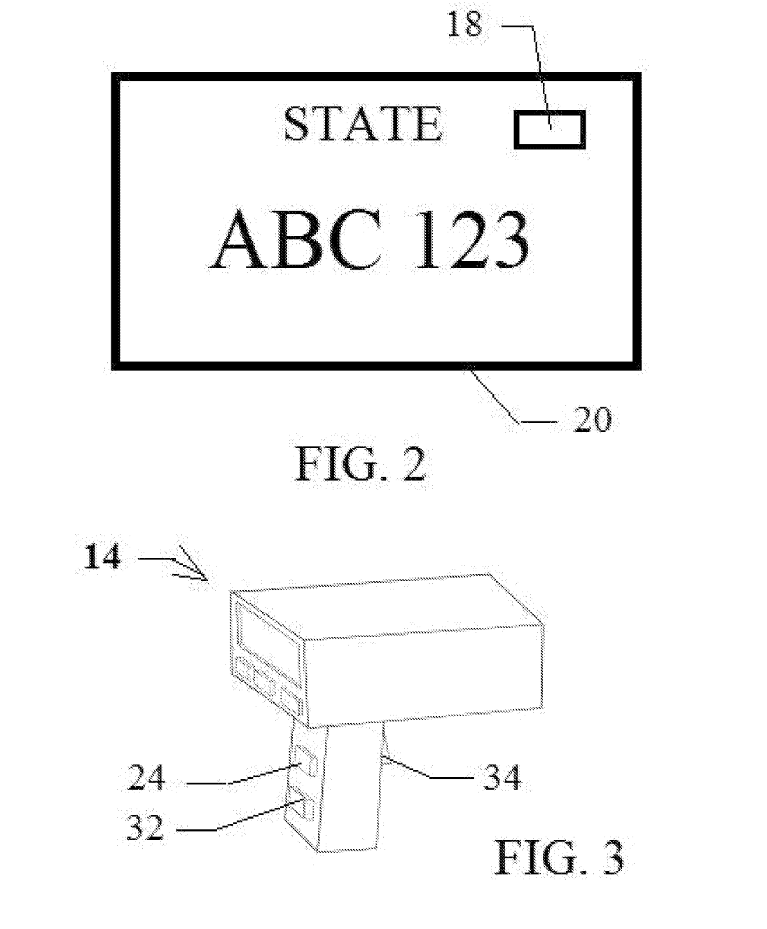

Referring now to the drawing and in particular to FIG. 1 and FIG. 2, a system according to the present invention is referred to generally by reference numeral 10. System 10 will disable a motorized vehicle 12 traveling on a street 11 and includes a modified police radar/laser gun 14 held and operated by a police officer 15 sitting in the passenger seat, a black box 16, known as a stinger or a Wi-Fi receiver or other device such as a chip 18 embedded in a license plate 20 of vehicle 12, normally a rear license plate, which can be easily aimed at in a chase situation by one or more police cars 22. Modified police radar/laser gun 14 stops vehicle 12 by shutting down the electrical system or by other means known in the art when activated by the modified police radar/laser gun. Black box 16 is attached to the motorized vehicle out of sight, such as under the hood, and is activated by the modified police radar/laser gun either directly or through chip 18 during a chase or other emergency situation. Chip 18 can be connected to black box 16 by wire or wireless. Just as a police radar/laser gun can single out an individual vehicle, so the modified police radar/laser gun can single out a single vehicle for disabling. Black box 16 is tamper proof so that any attempt to remove or otherwise tamper with it will disable vehicle 12 so that it will not start.

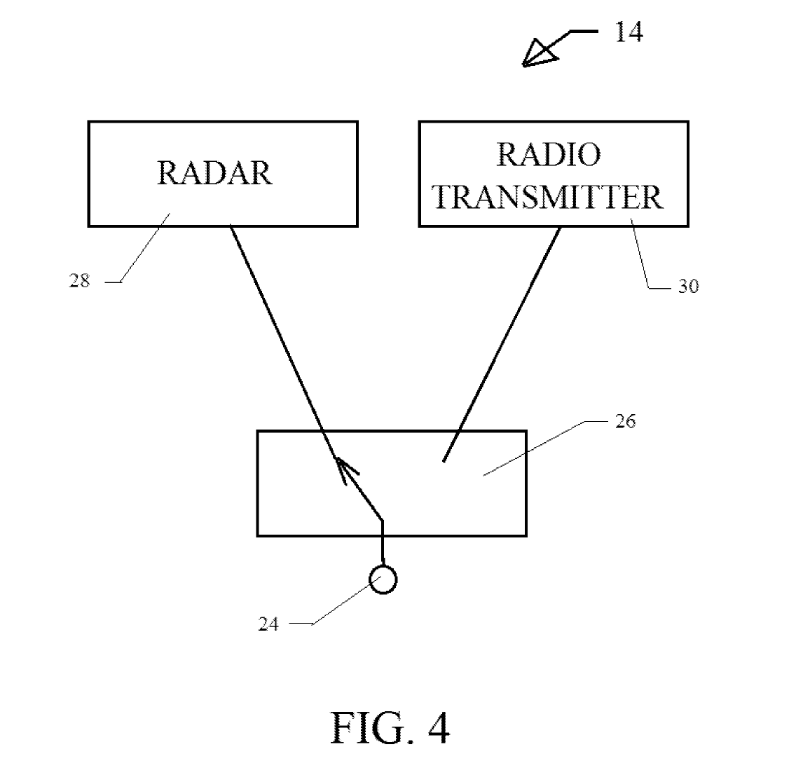

Referring now to FIG. 3 and to FIG. 4, modified radar/laser gun 14 can, by a touch button 24, activate a switch 26, which changes radar/laser gun 14 from a normal radar/laser gun 28 to a radio transmitter, an infrared transmitter or other wave transmitter 30 to activate chip 18 or directly activate black box 16.

The modified radar/laser gun can either be switched back to normal operation by activating switch through the same button 24 or a separate button 32. In either mode, modified radar/laser gun 14 is activated by a trigger 34.

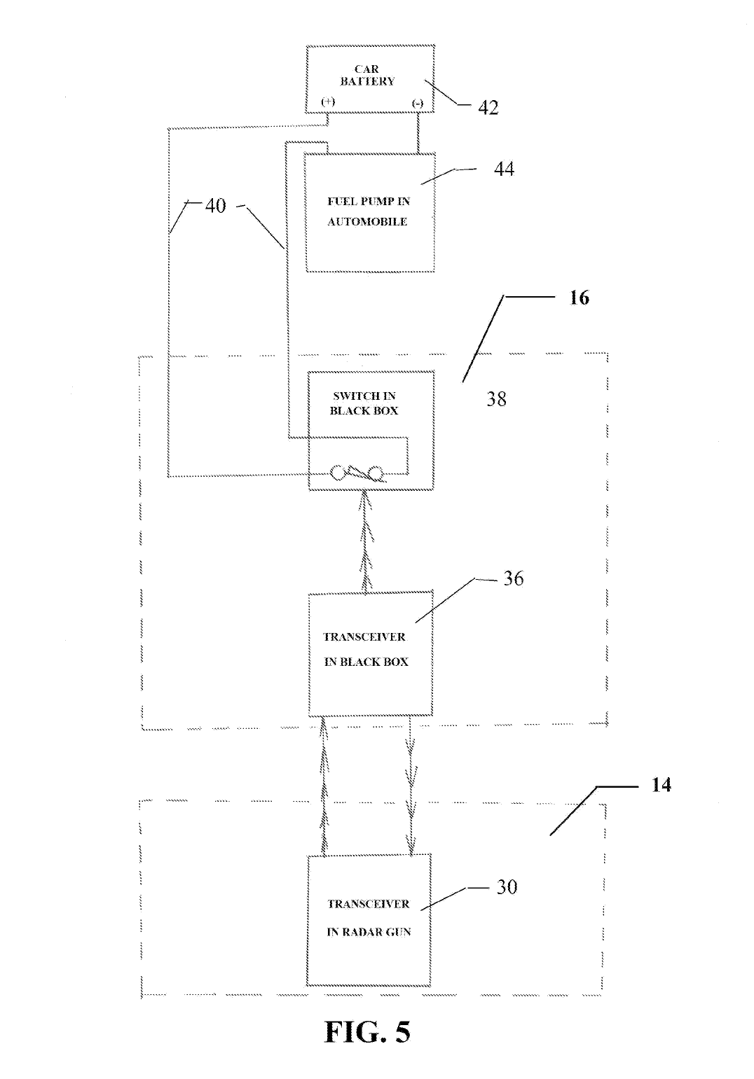

Referring now to FIG. 5, transmitter 30, which is a transceiver in this embodiment, transmits directly to transceiver 36 in black box 16. When transceiver 36 receives a signal from transceiver 30, transceiver 36 opens switch 38. Switch 38 is placed in series with the electrical connection 40 between battery 42 and fuel pump 44. Opening switch 38, thus disables fuel pump 44, bringing motorized vehicle 12 to a stop.

A system according to the present invention works on automobiles, trucks, buses, eighteen wheelers, recreational vehicles, motorcycles and boats.

Starting the vehicle readies the system. A system according to the present invention is well suited for police chases generally, but it is especially well suited for use with “bait cars” that are sometimes used by the police in areas with a lot of car theft.

From the foregoing it will be seen that this invention is well adapted to attain all of the ends and objectives hereinabove set forth, together with other advantages which are inherent to the apparatus.

It will be understood that certain features and subcombinations are of utility and may be employed without reference to other features and subcombinations. This is contemplated by and is within the scope of the claims.

As many possible embodiments may be made of the invention without departing from the scope thereof, it is to be understood that all matter herein set forth or shown in the figures of the accompanying drawings is to be interpreted as illustrative and not in a limiting sense.

1. A system for disabling a motorized vehicle, comprises:
a modified hand-held radar/laser gun, switchable between a normal radar/laser gun and a transmitter for transmitting a signal such as a radio signal, an infrared signal or other signal;
a black box located in the motorized vehicle capable of receiving, either directly or indirectly, a signal transmitted by the transmitter in the modified hand-held radar/laser gun;
a switch, which can be located in the black box or outside the black box, activated by the black box when the black box receives a signal from the transmitter, wherein changing the state of the switch brings the motorized vehicle to a stop.

2. A system according to claim 1, further including
a chip embedded in a license plate of motorized vehicle, normally a rear license plate, which can be easily aimed at in a chase situation by one or more police cars, wherein the chip communicates with the black box to transmit the signal to the black box.

3. A system according to claim 2, wherein the switch activated by the black box stops the motorized vehicle by shutting down the electrical system.

4. A system according to claim 2, wherein the switch opens the electrical wiring between the battery and the fuel pump.

5. A system according to claim 1 wherein the switch opens the electrical wiring between the battery and the fuel pump.
